(19) United States
(12) Patent Application Publication
(10) Pub. No.: US 2023/0026335 A1
(43) Pub. Date: Jan. 26, 2023

(54) Systems And Methods For Automated Processing Of Database Entries

(71) Applicant: Replacement Services, L.L.C., Belleville, IL (US)

(72) Inventors: Charles Kurt ARTINGER, Belleville, IL (US); Sameer DESHPANDE, Belleville, IL (US)

(21) Appl. No.: 17/869,369

(22) Filed: Jul. 20, 2022

Related U.S. Application Data
(60) Provisional application No. 63/283,783, filed on Nov. 29, 2021.
(60) Provisional application No. 63/223,709, filed on Jul. 20, 2021.

(51) Int. Cl. G06Q 10/10; G06F 16/25; G06F 3/0484; G06F 3/0482

(52) U.S. Cl. CPC G06Q 10/10; G06F 16/252; G06F 3/0484; G06F 3/0482

(57) ABSTRACT

A system for processing database entries includes a memory configured to store a database including multiple line item database entries and multiple receipt entries, a display including a user interface and a processor configured to execute instructions. The instructions include receiving a member identifier, obtaining at least a portion of the multiple line item database entries corresponding to the received member identifier, displaying the obtained multiple line item database entries, receiving a selection of one of the multiple receipt entries, and displaying an image of the selected receipt entry. The instructions further include receiving a selection of a location on the displayed image of the selected receipt entry, receiving a selection of one of the displayed multiple line item database entries, and storing, in the database, a relational link between the selected location on the displayed image of the selected receipt entry and the selected line item database entry.

### CROSS-REFERENCE TO RELATED APPLICATIONS

This application claims the benefit of U.S. Provisional Application No. 63/283,783, filed Nov. 29, 2021 and U.S. Provisional Application No. 63/223,709 filed Jul. 20, 2021. The entire disclosures of the above applications are incorporated herein by reference.

### FIELD

The present disclosure relates to systems and methods for automated processing of database entries, including line item database entries and linked receipt entries.

### BACKGROUND

This section provides background information related to the present disclosure which is not necessarily prior art.

An insurance company may insure contents inside a home such as couches, furniture and clothing. When an insured has a loss due to fire or theft, for example, an insurance company owes the insured for the contents. The most common type of insurance policy will pay a depreciated amount based on the useful life of an item, which is called actual cash value (ACV). The ACV is used for when the insured takes cash for an item and the item is not replaced.

If the insured replaces an item, then the insurance company may owe the insured for the replacement cost value (RCV), which is the full replacement value with no deprecation. Often the insurance company pays the ACV value early in the claim life cycle, and an insured then replaces an item after they have received the ACV. The insurance company must then pay the difference between the ACV and the RCV to the insured. In most cases, the insured must show the insurance company a copy of the receipt that proves they replaced the item, before the insurance company will pay the “holdover” difference between ACV and RCV.

### SUMMARY

This section provides a general summary of the disclosure, and is not a comprehensive disclosure of its full scope or all of its features.

According to one aspect of the present disclosure, an example system for processing database entries includes a memory configured to store a database and computer-executable instructions. The database includes multiple line item database entries and multiple receipt entries, with each line item database entry corresponding to an insured item, and each receipt entry including at least one purchase value corresponding to at least one of the multiple line item database entries. The system includes a display including a user interface configured to display the line item database entries and the receipt entries, and to receive an input from a user, and a processor configured to execute the instructions. The instructions include receiving, via the user interface, a member identifier, obtaining at least a portion of the multiple line item database entries corresponding to the received member identifier, displaying the obtained multiple line item database entries via the user interface, receiving a selection of one of the multiple receipt entries, and displaying an image of the selected receipt entry via the user interface. The instructions further include receiving a selection of a location on the displayed image of the selected receipt entry, receiving a selection of one of the displayed multiple line item database entries, and storing, in the database, a relational link between the selected location on the displayed image of the selected receipt entry and the selected one of the displayed multiple line item database entries.

According to another aspect of the present disclosure, an example method of processing line item database entries and receipt entries associated with insurance claims includes obtaining multiple line item database entries corresponding to a member identifier received via a user interface, displaying an image of a receipt entry associated with the received member identifier, and receiving a selection of a location on the displayed image of the receipt entry. The method further includes receiving a selection of one of the obtained multiple line item database entries, and storing, in a database, a relational link between the selected location on the displayed image of the receipt entry and the selected one of the multiple line item database entries.

According to yet another aspect of the present disclosure, an example non-transitory computer-readable medium stores processor-executable instructions, where the instructions include obtaining multiple line item database entries corresponding to a member identifier received via a user interface, displaying an image of a receipt entry associated with the received member identifier, and receiving a selection of a location on the displayed image of the receipt entry. The instructions also include receiving a selection of one of the obtained multiple line item database entries, and storing, in a database, a relational link between the selected location on the displayed image of the receipt entry and the selected one of the multiple line item database entries.

Further aspects and areas of applicability will become apparent from the description provided herein. It should be understood that various aspects of this disclosure may be implemented individually or in combination with one or more other aspects. It should also be understood that the description and specific examples herein are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is block diagram of a system for processing database entries, according to one example embodiment of the present disclosure.

FIG. 2 is a flowchart of a method for processing database entries, according to another example embodiment of the present disclosure.

FIG. 3 is an illustration of an example screen of a user interface of the system of FIG. 1.

FIG. 4 is an illustration of the screen of FIG. 3 showing a receipt entry for selection by a user.

FIG. 5 is an illustration of the screen of FIG. 3 showing an image of a selected receipt entry.

FIG. 6 is an illustration of the screen of FIG. 3 showing data entry fields at a selected location on the receipt entry.

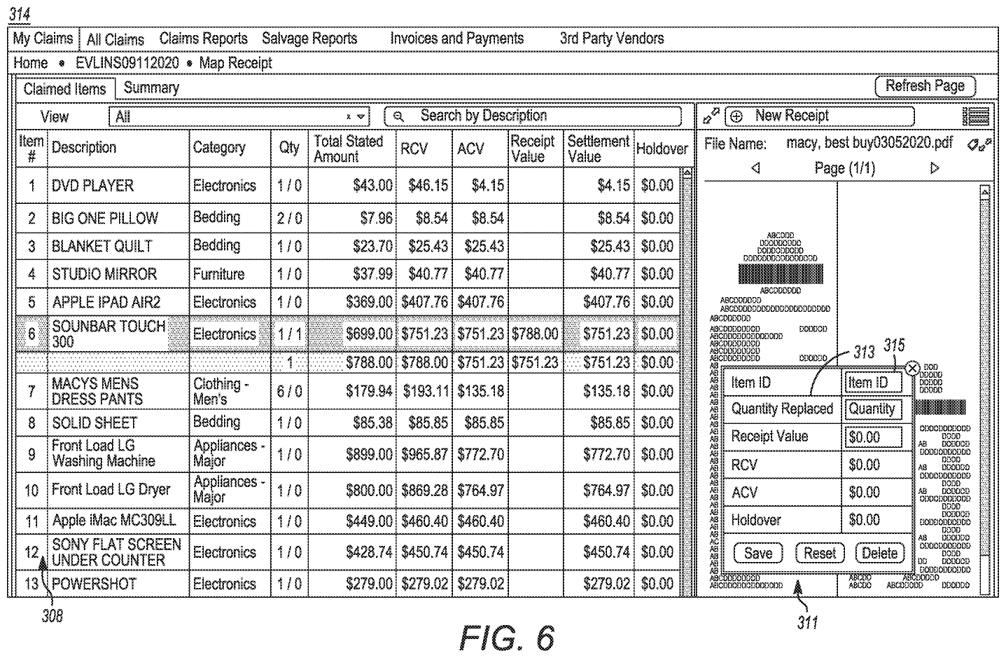

FIG. 7 is an illustration of the screen of FIG. 3 showing a subset of line item database entries according to a value in a search field.

FIG. 8 is an illustration of the screen of FIG. 3 showing calculated holdover amounts.

FIG. 9 is an illustration of the screen of FIG. 3 showing highlighted line item database entries having holdover amounts.

FIG. 10 is an illustration of the screen of FIG. 3 showing line item database entries for payment of holdover amounts.

Corresponding reference numerals indicate corresponding parts or features throughout the several views of the drawings.

### DETAILED DESCRIPTION

Example embodiments will now be described more fully with reference to the accompanying drawings.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

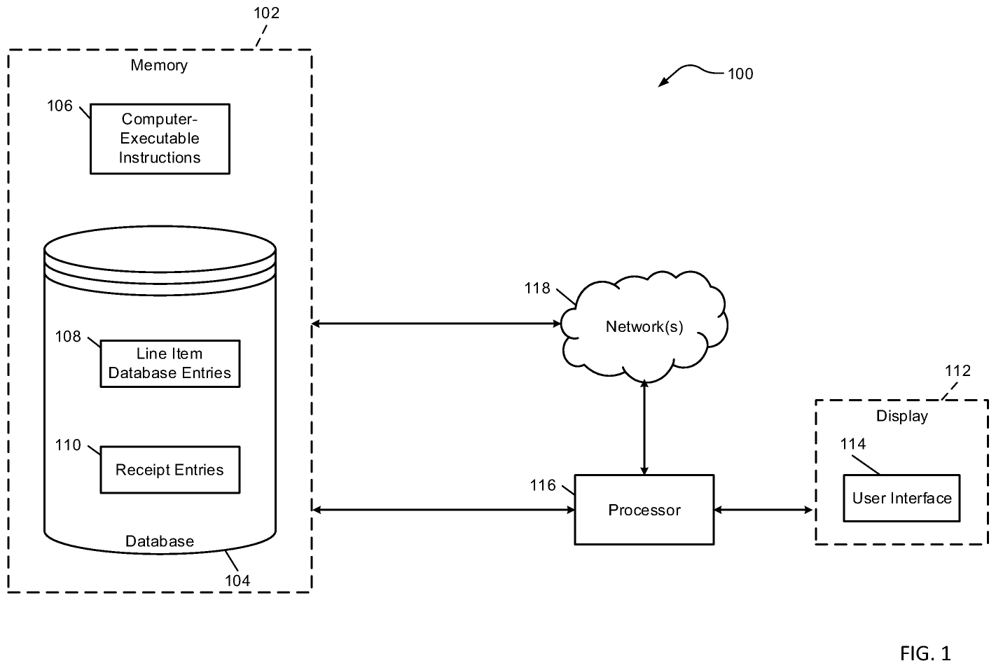

A system for processing database entries according to one example embodiment of the present disclosure is illustrated in FIG. 1 and indicated generally by reference number 100. The system 100 includes a memory 102 configured to store a database 104 and computer-executable instructions 106.

The database 104 includes multiple line item database entries 108 and multiple receipt entries 110. Each line item database entry 108 corresponds to an insured item, and each receipt entry 110 includes at least one purchase value corresponding to at least one of the multiple line item database entries 108.

The system 100 includes a display 112 including a user interface 114. The user interface 114 is configured to display the line item database entries 108 and the receipt entries 110, and to receive an input from a user. The system 100 also includes a processor 116 configured to execute the instructions.

The instructions include receiving, via the user interface 114, a member identifier, obtaining at least a portion of the line item database entries 108 corresponding to the received member identifier, and displaying the obtained line item database 108 entries via the user interface 114. The instructions also include receiving a selection of one of the receipt entries 110, and displaying an image of the selected receipt entry 110 via the user interface 114.

As shown in FIG. 1, the processor 116 and user interface 114 may communicate with the database 104 directly, via one or more networks 118, etc. For example, the display 112 and user interface 114 may be part of any suitable device for displaying text and receiving input from a user, including a desktop computer, a laptop computer, a tablet, a smartphone, etc. Example networks 118 may include a wireless network, a local area network (LAN), the Internet, a cellular network, etc.

The instructions further include receiving a selection of a location on the displayed image of the selected receipt entry 110, and receiving a selection of one of the displayed line item database entries 108. The instructions also include storing, in the database 104, a relational link between the selected location on the displayed image of the selected receipt entry 110 and the selected one of the displayed line item database entries 108.

Whenever an individual replaces an insured item, they typically must show a copy of the replacement item receipt to the insurance company to receive full payment of any holdover amount that is due. For example, an insured may send receipts to the insurance company in an envelope, and the insurance company copies the receipts into a PDF file, JPG format, etc., and attaches the files to a claim management system.

In some cases an insured may send hundreds of receipts to an insurance company, and the insurance company is tasked with matching all of the receipts to line items. Line items may be used to describe each item (or a quantity of items) that were lost, and are usually assigned a line item number. For example, a television may be assigned a line item number of 25 if the television was the 25th item listed as lost by the insured individual.

Often there is a quantity of items that were lost, such as ten men's shirts for example. An insured may replace five shirts, and the insurance company pays the RCV for the five replaced shirts, but there are still five shirts remaining where the insured was only paid the ACV. A month later, the insured may replace three more shirts from the original quantity of ten, and the insurance company must track and pay the RCV for the three more shirts that were replaced. This may be a difficult task for the insurance company, if the line item ACV and RCV is constantly changing. Claim management software does not account for multiple payments while deducting quantities that have not yet been replaced.

In various implementations described herein, a line item list of insured items that were lost may be uploaded into the software, which may or may not include ACV and RCV values. A user may create line items one by one on a smart phone, tablet, desktop, etc., may upload a complete file of line items, etc. A user interface may include a list of lost items on one portion of the screen (e.g., on the left side), and uploaded receipt documents (such as PDF documents, JPG images, etc.) may be displayed on another portion of the screen (e.g., on the right side).

A user can look at a receipt with a 55″ TV, enter a description of the item in a search box, and review matching line items on the line item list portion of the screen. Once a match is found, the user may click, touch, etc., at a desired location on the displayed PDF or other image of the receipt, and a data box opens on that location. For example, the user may select a location on the receipt that shows the purchase of the replacement item for the selected line item from the list.

In the data box, the user may enter any suitable information such as a line item number, receipt value, quantity purchased, etc. The user may save the information, and the data box entries and receipt location are then linked to the selected line item number. For example, a user may click on the desired line item number and the system may link the line item and the receipt location together.

Subsequently, a user may click on the line item at any time and the system will bring up the exact location on the PDF or other image of the receipt that was previously marked, tagged, etc. This process may be repeated for multiple receipt PDF files or other images, for multiple line item numbers, etc. In various implementations, the system 100 may allow for tagging coordinates of a line item on an electronic copy of a receipt, maintaining the tagged coordinates, running backend calculations for multiple quantities of items, and presenting information graphically on an image of the receipt.

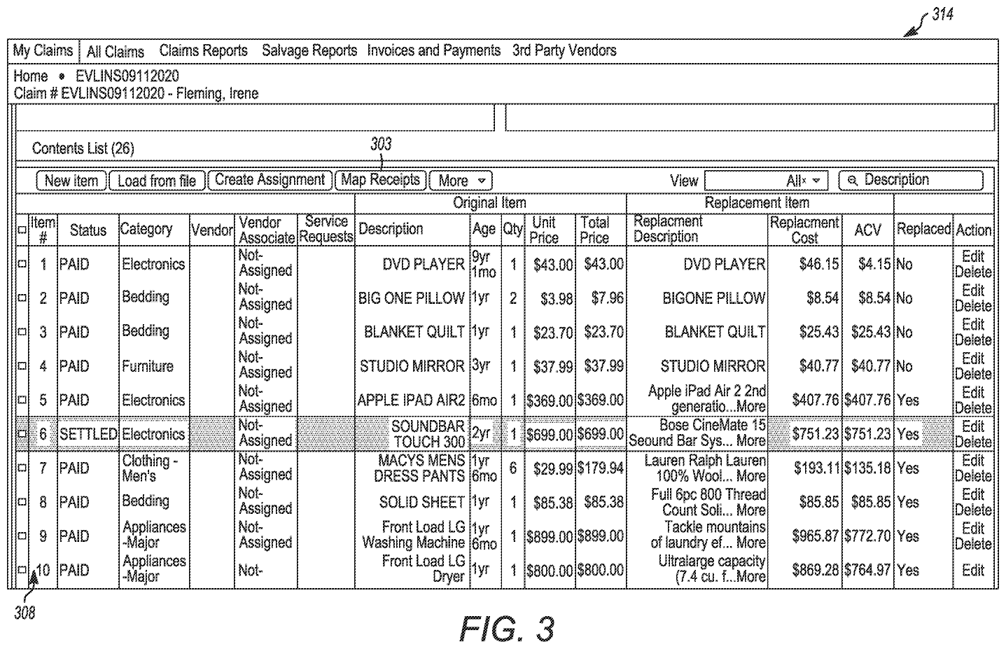

FIG. 3 illustrates an example display screen of the user interface 314, showing a list of line item database entries 308. For example, the line item database entries 308 may include a list of contents inside a hole that are claimed to have been stolen, damaged or destroyed. The list of line item database entries 308 may correspond to a specific member (e.g., an insured individual having an insurance policy for the items), and the list may be obtained in response to receiving a member identifier via the user interface 314 (e.g., when an insured individual signs in to an application, etc.).

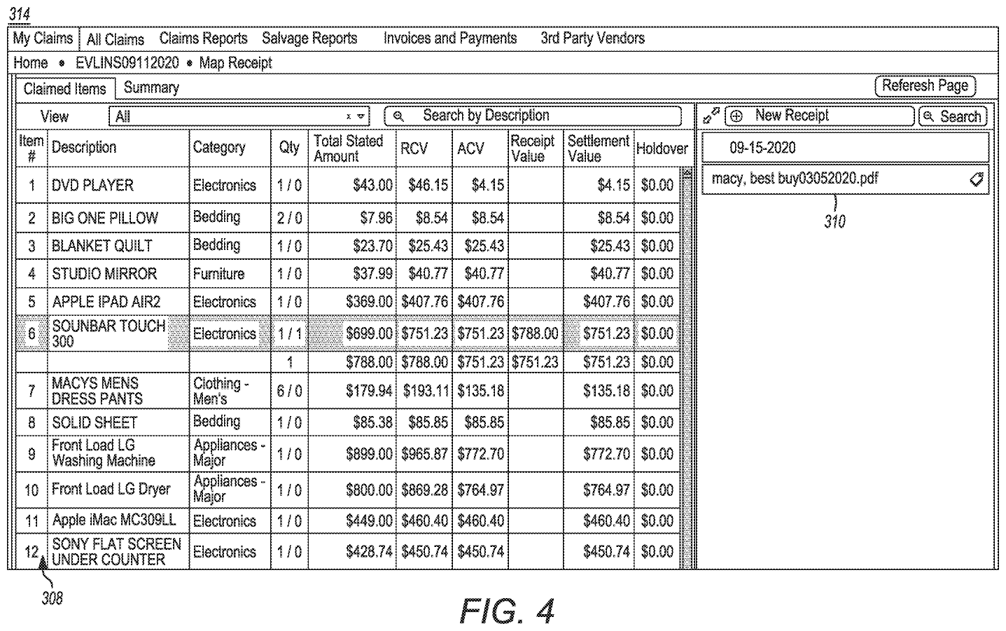

As shown in FIG. 3, the screen includes a map receipts button 303. When a user selects the map receipts button 303, the screen may display one or more receipt entries 310. An example of multiple displayed receipt entries 310 is illustrated in FIG. 4.

As shown in FIG. 4, to the left is a list of the line item database entries 308. On the right is a list of receipt entries 310, such as all receipt entries that have been uploaded by the user to provide proof of purchase of replacement items for insured items that were stolen, damaged or destroyed.

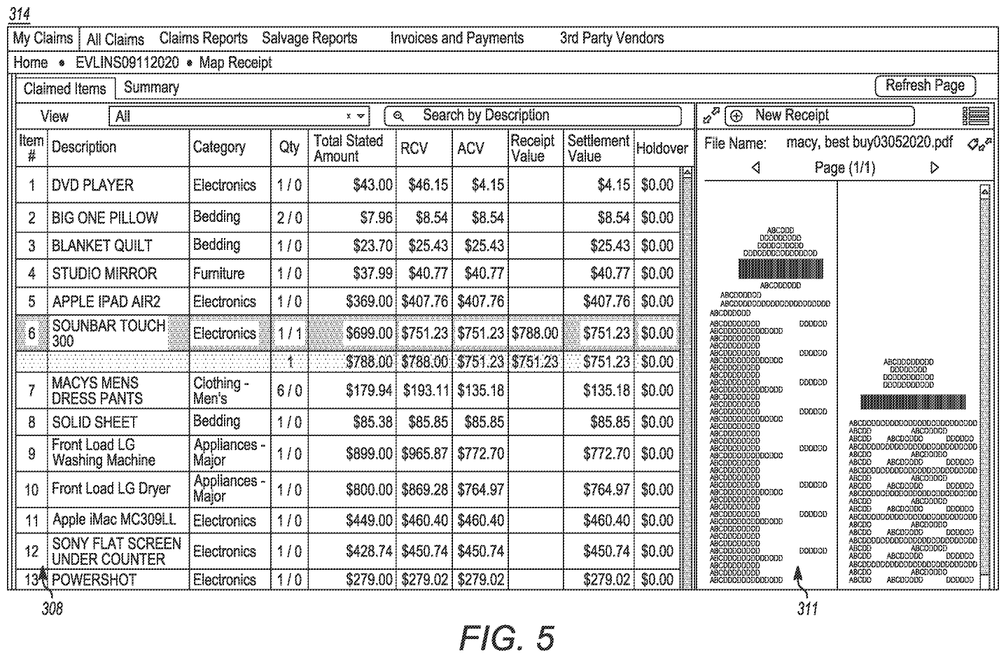

Each receipt entry 310 may include a metatag with one or more word identifiers, to make it easier to identify the contents or each receipt in a list format. Clicking on a receipt entry 310 may display an image 311 of the receipt entry, as shown in FIG. 5.

A user may select a location on the image 311 by clicking with a mouse cursor, contacting a touchscreen, etc. Coordinates of the selected location on the image may be obtained using any suitable technique, such as obtaining x and y pixel coordinates within the image 311, obtaining an exact GPS location in a PDF file of the image 311, etc.

In various implementations, the system 100 may build an artificial canvas corresponding to the width and height of the image 311, and virtually divide the canvas into multiple pixelated regions that can be tagged. For example, a back-end library such as the “pdf.js” community-driven open source tool supported by Mozilla Labs may be used to build and divide the artificial canvas corresponding to the image 311.

The actual contents of the image 311 may not be altered by the process of building and dividing the artificial canvas. In various implementations, the system 100 may use the artificial canvas to capture virtual coordinates of an item relative to dimensions of the image 311 to discretely identify a location of each mapped item. For example, when a user clicks on the image, coordinates of the location of the click with respect to dimensions of the image 311 may be mapped to corresponding coordinates in the artificial canvas. Therefore, the artificial canvas may store mapped locations for each item without altering the image 311.

Once a location on the image is selected, a data entry box 313 may be displayed adjacent the selected location (or any other suitable location on screen). The data entry box 313 may include one or more data entry fields 315 for the user to enter values corresponding to a purchase, such as an amount of a purchase, a replacement quantity purchased, a line item number of a purchased item, etc.

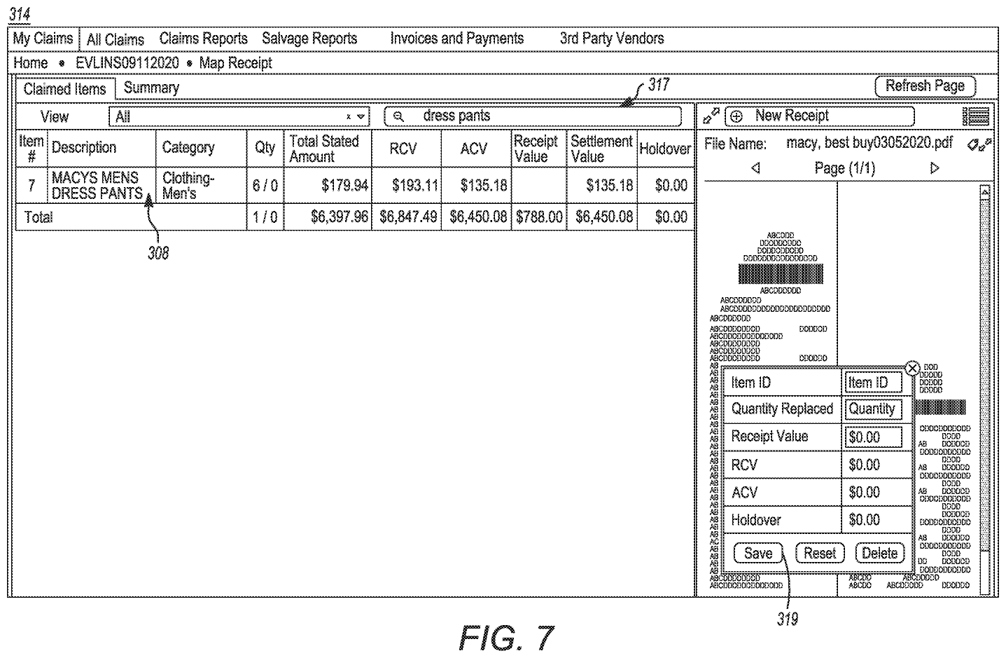

In order to assist in linking the selected location on the image 311 to a line item database entry 308, the user may access a search field 317 to narrow down a subset of the list of line item database entries 308. For example, FIG. 7 illustrates the user typing “dress pants” in the search field 317 in order to display only the line item database entry 308 that corresponds to “dress pants”.

Once the user finds the desired line item database entry 308 (e.g., an item claimed to be replaced as evidenced by the selected location on the receipt entry 310), the user may click on the desired line item database entry 308 to connect it with the receipt entry 310. The exact location that was tagged on the image 311 of the receipt entry 310 is associated with the selected line item database entry 308.

For example, the system 100 may utilize a GPS overlay to target a specific area of a document that has multiple pages (e.g., two pages, ten pages, twenty pages, etc.). In workflow software, a service request may be entered, a note may be entered into the system, etc. A user may open tag software, where a note is on the left and a PDF file is on the right. The user may tag an exact location of the PDF file, where a text box opens on the PDF file, a location marker is opened, etc. The user may tag the note, and the system 100 may link the exact location of the note to a line item database entry 308.

When the tagging software is closed, a user may be in a normal note section of workflow software. The user can open a note and click on a link icon, and the system 100 may open the PDF file and go to the exact location of the tag within the document. A user can create multiple notes on the left side of the software, and tag as many different documents as they would like. Although left and right sides are mentioned above for purposes of illustration, various implementations may use any suitable locations for displaying different elements during tagging of items.

In various implementations, the system 100 may assign a ‘line item ID’ or other suitable item identifier parameter to an item that is currently being mapped, and a ‘PDF ID’ or other suitable portable document format (PDF) identifier to the PDF that is uploaded. When the user is finished mapping an item to a specific section of a page of the PDF, the system 100 may store a combination of the ‘line item ID’ and ‘PDF ID’ along with, for example, a page number on which the item was mapped, and virtual ‘x’ and ‘y’ coordinates relative to the dimensions of the PDF.

These values (and/or any other suitable parameter values associated with the item mapping) may be stored immediately, and may be stored in any suitable location such as a relational database. Therefore, if a user tries to access a line item mapping, the exact PDF and location in the PDF may be available in order to display the mapped location on an image of a receipt for displaying to the user. For example, the system 100 may use the ‘line item ID’ and ‘PDF ID’ to retrieve a corresponding page number and virtual ‘x’ and ‘y’ coordinates, in order to display the correct page and coordinate location on the page for the user to view the mapped item on a receipt image.

If there are multiple receipt entries 308 uploaded into the system 100 (e.g., two receipts, ten receipts, one hundred receipts, etc.), while in receipt mapping mode a user can click on a line item database entry 308 and the system 100 will upload the receipt entry 310 that is linked with the line item database entry 308, and the exact location that was tagged on the image 311 of the linked receipt entry.

Once a user clicks on a save button 319 in the data entry box 313, the system 100 may automatically calculate a difference between an actual cash value (ACV, such as a depreciated value), and a replacement cost value (RCV). The difference between these two amounts may be referred to as a holdover or recoverable depreciation amount. The system 100 may calculate this amount to let an insurer know how much money should be paid back to an insured.

In various implementations, the system 100 may manage quantities of insured items. For example, if an insured lost six pairs of dress slacks and replaces three pairs, the system 100 may calculate a holdover amount for the three items that were replaced, and list the three remaining items that still have the potential for holdover if they are replaced separately in an additional line. At any time, a user may tag another receipt entry 310 when the remaining items are replaced, and enter a quantity of the additional items replaced. The system 100 may ensure that the additional replaced items will not exceed the original claimed quantity of items, nor the amount of the RCV value.

As another example, an insured may list a quantity of items such as ten shirts priced at $10 each. The insurance company may depreciate the shirts over a five-year lifespan. If the shirts are two years old, the shirts may be depreciated 40%, which is the ACV. An insured may replace five shirts and the insurance company may owe the difference between the ACV and RCV for five shirts, while also tracking the five remaining shirts that have not been replaced. The system may create a sub-line under the original line item database entry 308, and calculate the difference for five shirts. The system 100 may also show that there are still five shirts where the insured has only been paid the ACV.

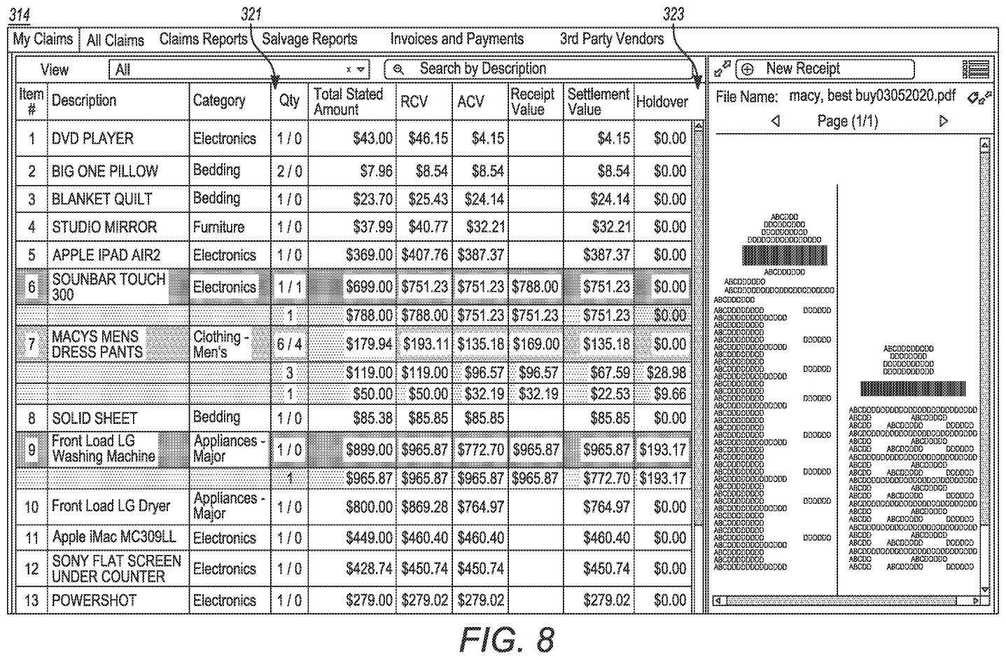

FIG. 8 illustrates example quantities 321 and holdover values 323 that have been calculated for different line item database entries 308. If the user returns to a main page, line item database entries 308 that have a holdover payment due may be highlighted, such as in a different color than other line item database entries 308.

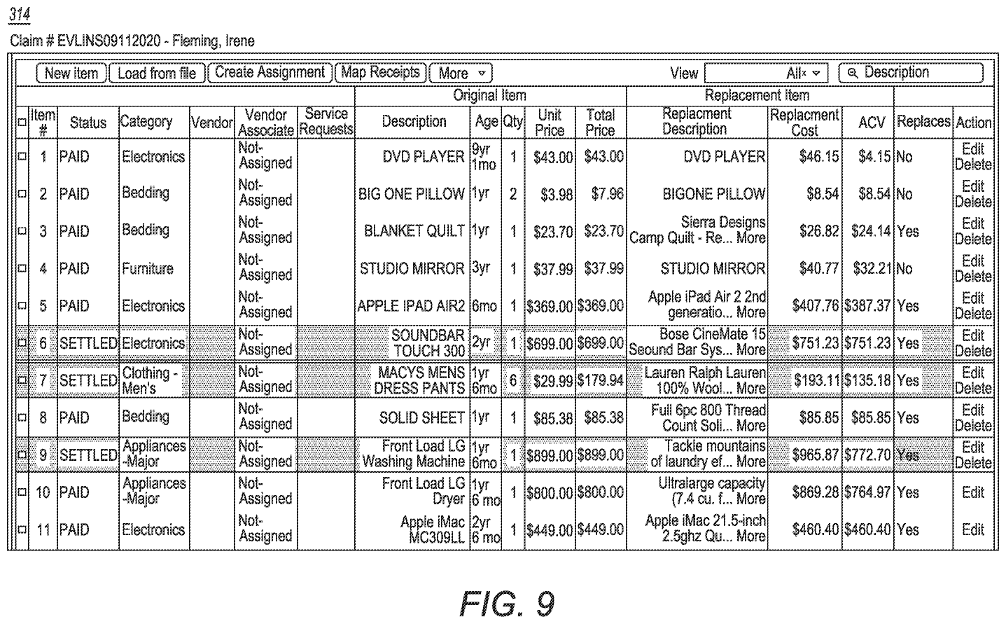

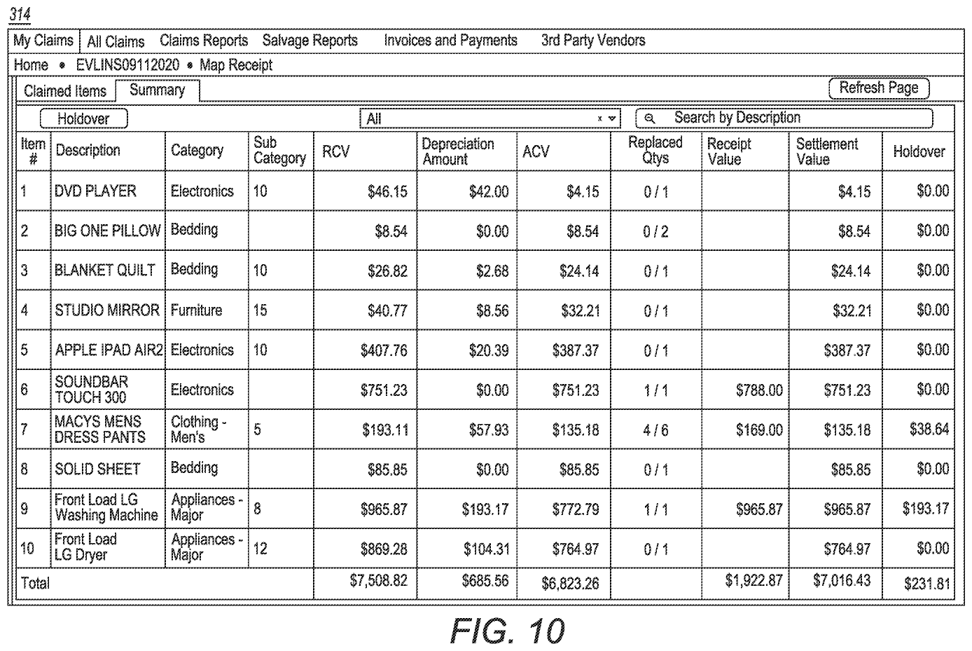

FIG. 9 illustrates an example screen where line item database entries 308 having a holdover payment due are identified. A user may then click on a claim summary tab to view the totals of holdover payments. An example claim summary page is illustrated in FIG. 10, where a user can select items with a holdover payment due to make a payment. The user may be able to include a payment ID number for a check or debit to an account of the insured member.

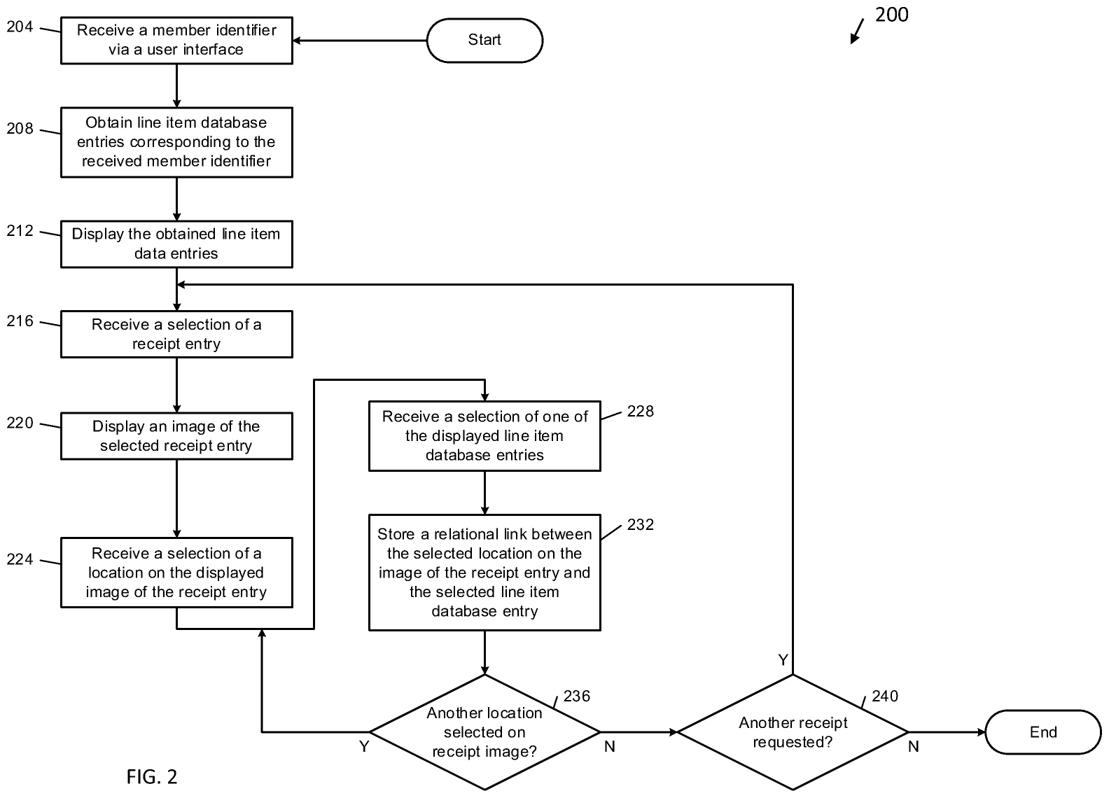

FIG. 2 illustrates an example method 200 for processing database entries, according to another example embodiment of the present disclosure. In various implementations, the method 200 may be performed by the system 100. As shown in FIG. 2, control begins at 204 by receiving a member identifier via a user interface (such as the user interface 114 of FIG. 1).

At 208, control obtains line item database entries (such as the line item database entries 108) corresponding to the received member identifier. Control then displays the obtained line item database entries via the user interface, at 212. At 216, control receives a selection of a receipt entry (such as one of the receipt entries 110), and displays an image of the selected receipt entry via the user interface at 220.

Control receives a selection of a location on the displayed image of the selected receipt entry at 224. At 228, control receives a selection of one of the displayed multiple line item database entries. Control then stores (e.g., in the database 104), a relational link between the selected location on the displayed image of the selected receipt entry and the selected one of the displayed multiple line item database entries, at 232.

At 236, control determines whether another location has been selected on the receipt image. If so, control returns to 228 to receive another selection of one of the displayed line item database entries to link with the additional selected location on the receipt image.

If no additional locations are selected on the receipt image at 236, control proceeds to 240 to determine whether another receipt has been requested (e.g., if the user indicates they would like to link another receipt to a line item data entry). If so, control returns to 216 to receive a selection of another receipt entry at 216. Once control determines at 240 that no further receipts are requested, control ends the process.

In various implementations, the method 200 may include, subsequent to storing the relational link in the database, receiving a selection of the line item database entry associated with the stored relational link via the user interface. In response to receiving the selection of the line item database entry associated with the stored relational link, the method 200 may include obtaining the receipt entry associated with the stored relational link, and displaying the image of the obtained receipt entry and the selected location on the displayed image of the obtained receipt entry, according to the selected location associated with the stored relational link.

Receiving the selection of the location may include at least one of receiving a cursor click on a specific coordinate of the displayed image of the receipt entry, and receiving a touch screen contact at a specific coordinate of the displayed image of the receipt entry. Storing the relational link may include storing, as a portion of the relational link, the specific coordinate of the displayed image of the receipt entry where the cursor click or the touch screen contact occurred.

In various implementations, the method 200 may include, in response to receiving the selection of the location, displaying one or more data entry fields on the user interface adjacent the selected location. The method 200 may include receiving, in at least one of the one or more data entry fields, a value input by the user. Storing the relational link may include storing, as a portion of the relational link, the value input by the user in the at least one of the one or more data entry fields.

The method 200 may include obtaining an actual cash value associated with the selected one of the displayed multiple line item database entries, and obtaining a replacement cost value associated with the selected one of the displayed multiple line item database entries. A holdover amount may be calculated according to the obtained actual cash value, the obtained replacement cost value, and the value input by the user. The holdover amount may be stored in association with the selected one of the displayed multiple line item database entries.

In various implementations, the method 200 may include displaying a search field via the user interface, receiving a search entry in the search field, and displaying a subset of the obtained multiple line item database entries according to the received search entry. Receiving the selection of one of the displayed multiple line item database entries may include receiving a selection of one of the displayed subset of the obtained multiple line item database entries.

According to another example embodiment of the present disclosure, a non-transitory computer-readable medium may store processor-executable instructions. The instructions may include obtaining multiple line item database entries corresponding to a member identifier received via a user interface, displaying an image of a receipt entry associated with the received member identifier, and receiving a selection of a location on the displayed image of the receipt entry. The instructions may also include receiving a selection of one of the obtained multiple line item database entries, and storing, in a database, a relational link between the selected location on the displayed image of the receipt entry and the selected one of the multiple line item database entries.

In various implementations, example systems may differentiate between replaced (e.g., mapped) items, and non-replaced (e.g., non-mapped items), when displaying line items to the user. A user may be allowed to search both mapped and non-mapped items by item ID, item description, etc.

The user may be able to view a category-wise split of replaced items, which may clearly indicate categories whose coverage limits have been reached or exceeded. The system may calculate a holdover amount against each category of items, and provide a total of the holdover amount for the claim. In various implementations, a user may be able to zoom into a PDF file or other image of a receipt in order to tag different regions.

Authorized users may be allowed to edit existing mappings in a database to update mappings, delete current mappings, etc. For example, authorized users may include policyholders, claim adjusters, supervisors, etc. The system may check for a valid session by an authenticated user prior to displaying claim information or allowing mapping of claim information.

In various implementations, the system may complete transactions (such as mapping actions) during a suitable time period, such as less than three seconds, less than two seconds, less than one second, etc. The system may be able to accommodate saving any suitable size and amount of receipt files, such as PDF files ranging in size of up to 17 MB or more, handling uploads and rendering of up to 10× or more of PDF files and metadata for storage in the database, etc. The system may be able to render up to 300 line items or more on the screen and support relevant database actions, etc.

Example systems described herein may provide one or more (or none) of the following benefits: reduced time and effort by an adjuster to resolve replaced items, increased transparency of the replacement process for the policyholder, more accurate holdover totals for the adjuster, facilitating checks by the adjuster for categories where coverage limits have been reached or exceeded, reduction or elimination of the problem of auditing a mapping of receipts to line items after a process is completed, and reduction or elimination of the problem of having to enter or submit one receipt for each replaced line item.

As described herein, the example systems may include a microprocessor, microcontroller, integrated circuit, digital signal processor, etc., which may include memory. The systems, processors, etc. may be configured to perform (e.g., operable to perform, etc.) any of the example processes described herein using any suitable hardware and/or software implementation. For example, the systems, processors, etc. may execute computer-executable instructions stored in a memory, may include one or more logic gates, control circuitry, etc.

For example, systems described herein may include processor hardware (shared, dedicated, or group) that executes code, and memory hardware (shared, dedicated, or group) that stores code executed by the processor hardware. The systems may include one or more interface circuits. In some examples, the interface circuit(s) may implement wired or wireless interfaces that connect to a local area network (LAN) or a wireless personal area network (WPAN). Examples of a LAN are Institute of Electrical and Electronics Engineers (IEEE) Standard 802.11-2016 (also known as the WIFI wireless networking standard) and IEEE Standard 802.3-2015 (also known as the ETHERNET wired networking standard). Examples of a WPAN are IEEE Standard 802.15.4 (including the ZIGBEE standard from the ZigBee Alliance) and, from the Bluetooth Special Interest Group (SIG), the BLUETOOTH wireless networking standard (including Core Specification versions 3.0, 4.0, 4.1, 4.2, 5.0, and 5.1 from the Bluetooth SIG).

Components of the system may communicate with other components using the interface circuit(s). Although the components may be depicted in the present disclosure as logically communicating directly with other components, in various implementations the module may actually communicate via a communications system. The communications system may include physical and/or virtual networking equipment such as hubs, switches, routers, and gateways. In some implementations, the communications system connects to or traverses a wide area network (WAN) such as the Internet. For example, the communications system may include multiple LANs connected to each other over the Internet or point-to-point leased lines using technologies including Multiprotocol Label Switching (MPLS) and virtual private networks (VPNs).

In various implementations, the functionality of a component may be distributed among multiple components that are connected via the communications system. For example, multiple components may implement the same functionality distributed by a load balancing system. In a further example, the functionality of the component may be split between a server (also known as remote, or cloud) module and a client (or, user) module. For example, the client module may include a native or web application executing on a client device and in network communication with the server module.

Software applications and software code may include software, firmware, and/or microcode, and may refer to programs, routines, functions, classes, data structures, and/or objects. Shared processor hardware may encompass a single microprocessor that executes some, all code from multiple modules, etc. Group processor hardware may encompass a microprocessor that, in combination with additional microprocessors, executes some or all code from one or more modules. References to multiple microprocessors may encompass multiple microprocessors on discrete dies, multiple microprocessors on a single die, multiple cores of a single microprocessor, multiple threads of a single microprocessor, a combination of the above, etc.

Shared memory hardware may encompass a single memory device that stores some or all code from multiple modules. Group memory hardware may encompass a memory device that, in combination with other memory devices, stores some or all code from one or more modules.

The term memory hardware may be a subset of the term computer-readable medium. The term computer-readable medium, as used herein, does not encompass transitory electrical or electromagnetic signals propagating through a medium (such as on a carrier wave); the term computer-readable medium is therefore considered tangible and non-transitory. Non-limiting examples of a non-transitory computer-readable medium are nonvolatile memory devices (such as a flash memory device, an erasable programmable read-only memory device, or a mask read-only memory device), volatile memory devices (such as a static random access memory device or a dynamic random access memory device), magnetic storage media (such as an analog or digital magnetic tape or a hard disk drive), and optical storage media (such as a CD, a DVD, or a Blu-ray Disc).

The systems, apparatuses and methods described in this application may be partially or fully implemented by a special purpose computer created by configuring a general purpose computer to execute one or more particular functions embodied in computer programs. Such systems, apparatuses and methods may be described as computerized apparatuses and computerized methods. The functional blocks and flowchart elements described above serve as software specifications, which may be translated into the computer programs by the routine work of a skilled technician or programmer.

The computer programs may include processor-executable instructions that are stored on at least one non-transitory computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language), XML (extensible markup language), or JSON (JavaScript Object Notation), (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective C, Swift, Haskell, Go, SQL, R, Lisp, Java®, Fortran, Perl, Pascal, Curl, OCaml, JavaScript®, HTML5 (Hypertext Markup Language 5th revision), Ada, ASP (Active Server Pages), PHP (PHP: Hypertext Preprocessor), Scala, Eiffel, Smalltalk, Erlang, Ruby, Flash®, Visual Basic®, Lua, MATLAB, SIMULINK, and Python®.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

1. A system for processing database entries, the system comprising:
a memory configured to store a database and computer-executable instructions, the database including multiple line item database entries and multiple receipt entries, each line item database entry corresponding to an insured item, and each receipt entry including at least one purchase value corresponding to at least one of the multiple line item database entries;
a display including a user interface configured to display the line item database entries and the receipt entries, and to receive an input from a user; and
a processor configured to execute the instructions, wherein the instructions include:
receiving, via the user interface, a member identifier;
obtaining at least a portion of the multiple line item database entries corresponding to the received member identifier;
displaying the obtained multiple line item database entries via the user interface;
receiving a selection of one of the multiple receipt entries;
displaying an image of the selected receipt entry via the user interface;
receiving a selection of a location on the displayed image of the selected receipt entry;
receiving a selection of one of the displayed multiple line item database entries; and
storing, in the database, a relational link between the selected location on the displayed image of the selected receipt entry and the selected one of the displayed multiple line item database entries.

2. The system of claim 1, wherein the instructions further include:
subsequent to storing the relational link in the database, receiving a selection of the line item database entry associated with the stored relational link via the user interface; and
in response to receiving the selection of the line item database entry associated with the stored relational link:
obtaining the receipt entry associated with the stored relational link; and
displaying the image of the obtained receipt entry and the selected location on the displayed image of the obtained receipt entry, according to the selected location associated with the stored relational link.

3. The system of claim 1, wherein receiving the selection of the location includes at least one of receiving a cursor click on a specific coordinate of the displayed image of the selected receipt entry, and receiving a touch screen contact at a specific coordinate of the displayed image of the selected receipt entry.

4. The system of claim 3, wherein storing the relational link includes storing, as a portion of the relational link, the specific coordinate of the displayed image of the selected receipt entry where the cursor click or the touch screen contact occurred.

5. The system of claim 3, wherein the instructions further include, in response to receiving the selection of the location, displaying one or more data entry fields on the user interface adjacent the selected location.

6. The system of claim 5, wherein:
the instructions include receiving, in at least one of the one or more data entry fields, a value input by the user; and
storing the relational link includes storing, as a portion of the relational link, the value input by the user in the at least one of the one or more data entry fields.

7. The system of claim 5, wherein the one or more data entry fields includes at least one of a purchase value entry field, a quantity entry field, and a line item number entry field.

8. The system of claim 6, wherein the instructions further include:
obtaining an actual cash value associated with the selected one of the displayed multiple line item database entries;
obtaining a replacement cost value associated with the selected one of the displayed multiple line item database entries;
calculating a holdover amount according to the obtained actual cash value, the obtained replacement cost value, and the value input by the user; and
storing the holdover amount in association with the selected one of the displayed multiple line item database entries.

9. The system of claim 8, wherein:
receiving the value input by the user includes receiving a quantity purchased value of the selected one of the displayed multiple line item database entries; and
calculating the holdover amount includes calculating the holdover amount according to the received quantity purchased value.

10. The system of claim 8, wherein the instructions further include, subsequent to receiving the value input by the user, displaying each of the multiple line item database entries including identifying one of the multiple line item database entries having an associated stored holdover amount.

11. The system of claim 1, wherein the instructions further include:
displaying a map receipts button via the user interface on a same display screen as the obtained multiple line item database entries; and
in response to receiving a selection of the map receipts button, obtaining at least one of the multiple receipt entries that corresponds to the member identifier; and
displaying the obtained receipt entry via the user interface, prior to receiving the selection of the at least one receipt entry.

12. The system of claim 11, wherein each receipt entry includes a metatag word identifier, and displaying the obtained receipt entry includes displaying at least a portion of the metatag word identifier of the obtained receipt entry.

13-14. (canceled)

15. A method of processing line item database entries and receipt entries associated with insurance claims, the method comprising:
obtaining multiple line item database entries corresponding to a member identifier received via a user interface;
displaying an image of a receipt entry associated with the received member identifier;
receiving a selection of a location on the displayed image of the receipt entry;
receiving a selection of one of the obtained multiple line item database entries; and
storing, in a database, a relational link between the selected location on the displayed image of the receipt entry and the selected one of the multiple line item database entries.

16. The method of claim 15, further comprising:
subsequent to storing the relational link in the database, receiving a selection of the line item database entry associated with the stored relational link via the user interface; and
in response to receiving the selection of the line item database entry associated with the stored relational link:
obtaining the receipt entry associated with the stored relational link; and
displaying the image of the obtained receipt entry and the selected location on the displayed image of the obtained receipt entry, according to the selected location associated with the stored relational link.

17. The method of claim 15, wherein receiving the selection of the location includes at least one of receiving a cursor click on a specific coordinate of the displayed image of the receipt entry, and receiving a touch screen contact at a specific coordinate of the displayed image of the receipt entry.

18. The method of claim 17, wherein storing the relational link includes storing, as a portion of the relational link, the specific coordinate of the displayed image of the receipt entry where the cursor click or the touch screen contact occurred.

19. The method of claim 15, wherein the instructions further include, in response to receiving the selection of the location, displaying one or more data entry fields on the user interface adjacent the selected location.

20. The method of claim 19, further comprising receiving, in at least one of the one or more data entry fields, a value input by the user;
wherein storing the relational link includes storing, as a portion of the relational link, the value input by the user in the at least one of the one or more data entry fields.

21-22. (canceled)

23. A non-transitory computer-readable medium storing processor-executable instructions, the instructions comprising:
obtaining multiple line item database entries corresponding to a member identifier received via a user interface;
displaying an image of a receipt entry associated with the received member identifier;
receiving a selection of a location on the displayed image of the receipt entry;
receiving a selection of one of the obtained multiple line item database entries; and
storing, in a database, a relational link between the selected location on the displayed image of the receipt entry and the selected one of the multiple line item database entries.

24. The system of claim 1,
wherein storing the relational link includes storing, as a portion of the relational link, one or more item settlement parameter values corresponding to the selected one of the displayed multiple line item database entries.

25-26. (canceled)
